(19) United States
(12) Patent Application Publication
(10) Pub. No.: US 2016/0229306 A1
(43) Pub. Date: Aug. 11, 2016

(54) NETWORKED UNIVERSAL ELECTRIC VEHICLE CHARGING SYSTEM WITH SOCIAL MEDIA CUSTOMER OUTREACH

(71) Applicant: Bruce Brimacombe, Mesa, AZ (US)

(72) Inventor: Bruce Brimacombe, Mesa, AZ (US)

(21) Appl. No.: 15/130,895

(22) Filed: Apr. 15, 2016

Related U.S. Application Data
(63) Continuation-in-part of application No. 13/950,214, filed on Jul. 24, 2013.
(60) Provisional application No. 61/675,809, filed on Jul. 25, 2012.

(51) Int. Cl. B60L 11/18; G06Q 30/02

(52) U.S. Cl. CPC B60L 11/1848; G06Q 30/0261; G06Q 30/0255; B60L 11/185

(57) ABSTRACT

An electric vehicle charging station system has numerous charging nodes, each charging node including a charging station having at least two electric vehicle supply equipment selected from the group consisting of a Level 1 charging device, a Level 2 charging device, an automobile brand-specific charging device, and a Level 3/Fast DC charging device, wherein the plurality of charging nodes are in communication with each other through a network. A display device is disposed on each charging station, the display device having one or more portals that display a web-based or consumer-focused content, wherein a portion of the content is provided by a vendor that provides a good or service concentrically located within a predetermined distance to the system, and another portion of the content provides the location of adjacent charging nodes to a consumer using the system to charge an electric vehicle. A selection device allows the consumer to select a particular portal, wherein the selection device transmits the selected content to a mobile device associated with the consumer.

### RELATED APPLICATIONS

This application is a continuation-in-part of pending U.S. Ser. No. 13/950,214, filed Jul. 24, 2013, which claims the benefit of U.S. Provisional Patent Application No. 61/675,809, filed on Jul. 25, 2012, which is hereby incorporated by reference.

### TECHNICAL FIELD

The inventions described herein are directed to charging nodes for networked electric vehicle (EV) and to charging stations having at least two different types of charging connectors and the ability for a consumer to receive web-based or consumer-focused information.

### BACKGROUND

Electric Vehicles (EV), much like the conventional internal combustion engine powered vehicles, have a finite range. EVs are three to five times more efficient as internal combustion vehicles, cost less to drive and maintain, and offer zero air pollution. In spite of these advantages, the limited number of charging options available outside the urban city regions hinders the market penetration of EVs. There are numerous petroleum refueling spots along interstates, state highways and large secondary roads allowing people to travel between cities and states using conventional vehicles. However, there are very few EV charge stations on the highway and freeway systems, and currently there is no network allowing EV drivers to travel coast-to-coast or even between states. For this EV technology to succeed, a large-scale charging network is vital. Further, conventional economics stifle the progress of such a network inception, and a new multi-facet solution is needed.

### SUMMARY OF INVENTION

In one embodiment there is disclosed an electric vehicle charging station system comprising: a) a plurality of charging nodes, each charging node including a charging station having at least two electric vehicle supply equipment selected from the group consisting of a Level 1 charging device, a Level 2 charging device, an automobile brand-specific charging device, and a Level 3/Fast DC charging device, wherein the plurality of charging nodes are in communication with each other through a network; The plurality of charging method inputs includes, but is not limited to, a CHAdeMO quick charging input, a J1772E charging input, and a 70 A Level II EV input. b) a display device disposed on each charging station, the display device having one or more portals that display a web-based or consumer-focused content, wherein a portion of the content is provided by a vendor that provides a good or service concentrically located within a predetermined distance to the system, and another portion of the content provides the location of adjacent charging nodes to a consumer using the system to charge an electric vehicle; and c) a selection device that allows the consumer to select a particular portal, wherein the selection device transmits the selected content to a mobile device associated with the consumer.

### BRIEF DESCRIPTION OF DRAWINGS

FIG. 1A is an overview that shows a U.S. map and possible recharging station linkages.

FIG. 1B is a schematic of a charging station.

FIG. 2 shows a universal quick charging station system 50 that forms a part of each node 12, 14, 16, etc.

FIG. 3 shows a schematic of the charging station displaying web- or consumer-centric content.

FIG. 4 displays a screen of the inventive app.

FIG. 5 shows a screen for selecting TV programs.

FIG. 6 shows a screen for contests and viewing them in progress.

FIG. 7 shows a screen for following a selected contest.

FIG. 8 shows a screen for coupons.

FIG. 9 shows a screen with previously selected favorite coupons.

FIG. 10 shows a rock show competition with View Status and Vote capability.

FIG. 11 shows a user favorite function on a trip plan.

FIG. 12 shows a screen with a “reality” view and favorite establishments with their logos.

FIG. 13 shows an example of a trip route with additional favorite establishments enroute.

FIG. 14 displays more information about the trip of FIG. 13.

FIG. 15 also displays trip information.

FIG. 16 provides a different way of looking at the same trip.

FIG. 17 shows a proposed restaurant deal that the software selects based on user profile selections and past history.

FIG. 18 shows yet another trip screen for the user to access more information via the software.

### DETAILED DESCRIPTION

For EV technology to succeed, a large scale charging network is vital. Further conventional economics stifle the progress of such a network's inception, and a new multi-faceted solution is needed. Even for EVs having a large mileage capability, such as automobile brand-specific vehicles, which generally have a 240-mile range on a single charge, it became evident that with such a great range, they are still limited to urban travel only. For EVs to become a fully functional part of American life, a coast-to-coast charging network will ensure the greatest success. From a financial perspective, EV chargers are not viable in a classical business model. However, once we began integrating web services and content, we found the initial cost of the system to be viable.

We have continued to develop the system to offer voice integration, which decreases problems with distracted driving due to drivers studying screens. The voice integration and other smart technology make the system more of a “serving docent,” in contrast to the dumb connections offered by others. We also provide access to buy tickets and rooms via integration with hotel booking systems, such that the user need not leave our system to reserve and pay for rooms. Based on user profiles as well as historical activity, the system proposes activities, hotels, etc. that the user is known to prefer; this function also saves users a lot of time, effort and distraction.

As used herein, “EV” includes all types of vehicles that use electrical energy to provide locomotion, including, but not limited to, all-electric vehicles and hybrid vehicles. The system allows the consumer to view regional information, amongst other web-content, and choose to have select information sent to their mobile device.

Currently, there are three types of charging connectors used to recharge the batteries of EVs. These include Level 1, Level 2 and Level 3/Direct-current (DC) fast charging:
a) Level 1 provides charging through a 120-volt (V) AC plug and requires electrical installation per the National Electrical Code. Most, if not all, EVs will come with a Level 1 cord set so that no additional charging equipment is required. On one end of the cord is a standard, three-prong household plug (NEMA 5-15 connector). On the other end is a JI 772 standard connector, which plugs into the vehicle. Level 1 is typically used for charging when there is only a 120 V outlet available. Based on the battery type and vehicle, Level 1 charging adds about 2 to 5 miles of range to an EV per hour of charging time.
b) Level 2 equipment offers charging through 240 V (typical in residential applications) or 208 V (typical in commercial applications) electrical services. Level 2 charging requires installation of home charging or public charging equipment and a dedicated circuit of 20 to 80 amps, depending on the EV requirements. This charging option can operate at up to 80 amperes and 19.2 kW. However, most residential Level 2 charging equipment will operate at lower power. Many such units operate at up to 30 amperes, delivering 7.2 kW of power. These units require a dedicated 40-amp circuit. Most homes have 240 V service available, and because Level 2 charging equipment can easily charge a typical EV battery overnight, this will be a common installation for homes. Level 2 equipment also uses the same connector on the vehicle as Level 1 equipment. Based on the battery type and circuit capacity, Level 2 adds about 10 to 20 miles of range per hour of charging time, depending on the vehicle.
c) Level 3, also known as direct-current (DC) fast-charging equipment (480 V AC or 208 V AC three phase input) enables rapid charging along heavy traffic corridors and at public stations. A DC fast charge can add 60 to 80 miles of range to a light-duty EV in about 20 minutes.

Inductive charging equipment, which uses an electromagnetic field to transfer electricity to an EV without a cord, is still being used in certain areas where it was installed for EVs in the 1990 s. Currently available plug-in vehicles do not use inductive charging, but SAE International is working on a standard that may apply in the future.

Most modern charging equipment and EVs have a standard connector and receptacle based on the SAE JI 772 standard developed by SAE International. Any vehicle with this plug receptacle should be able to use any JI 772-compliant Level 1 or Level 2 charging equipment. All major vehicle and charging system manufacturers support this standard in the U.S., which should eliminate drivers' concerns about whether their vehicles are compatible with the infrastructure. Some currently available plug-in vehicles that are equipped to accept DC fast charging are using the CHAdeMO connector. SAE International is also working on a “hybrid connector” standard for fast charging that adds high-voltage DC power contact pins to the JI 772 connector, enabling use of the same receptacle for all levels of charging. Automobile brand-specific companies refer to their plugs as “universal” mobile connector plugs/ports.

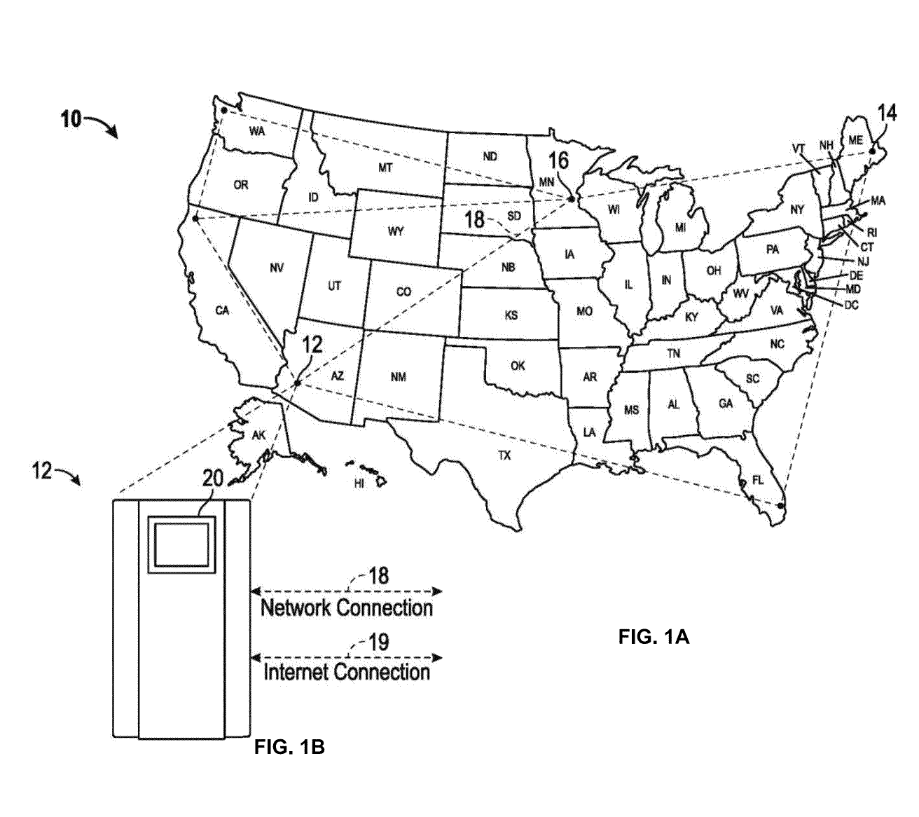

In one embodiment as shown in FIG. 1A, a universal charging node/system 10 includes many individual charging stations or nodes 12, 14, 16, etc. spanning across more than one state linking together EV vehicle charging stations and forming a coast to coast network across the United States. As shown in FIG. 1B, each node includes at least one Level 3 and/or Level 2 charging station(s). Each node also includes a display device 20 connected to the Internet and is capable of interchanging web-based content and information. Each node 12, 14, 16, etc. communicates through a wired, Wi-Fi, or cell phone communication system 18 and to the Internet 19 as an integral part of the network. Nodes receive and report all activity experienced doing operation.

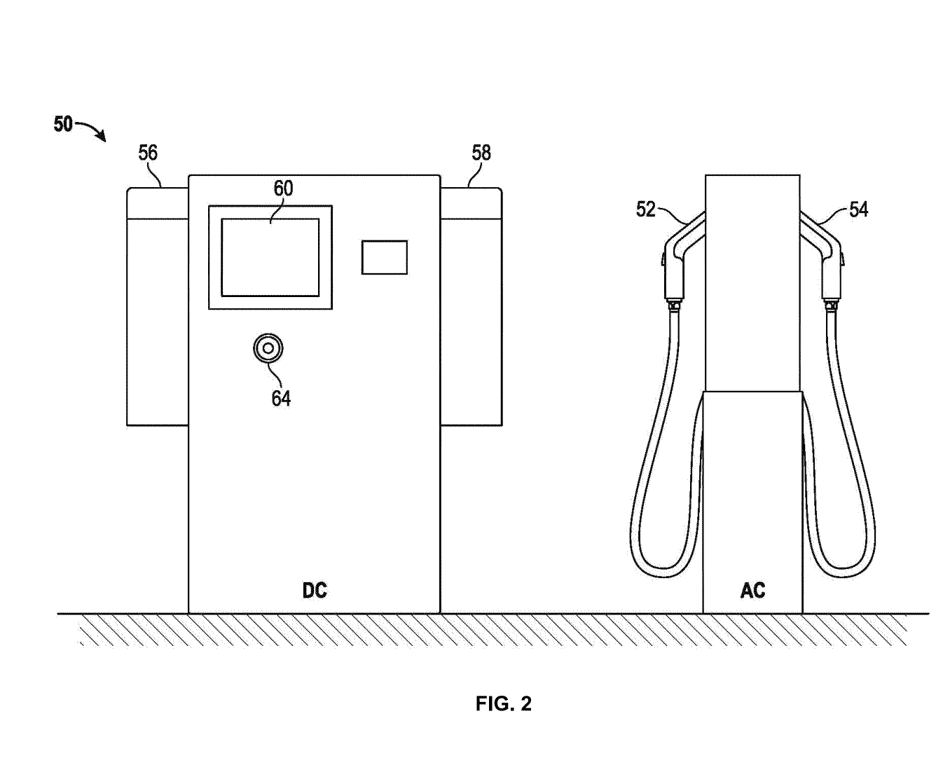

FIG. 2 shows a quick charging station system 50 that forms a part of each node 12, 14, 16, etc. These may be catalog numbers “u” universal, “s” stand alone, or “E3” for full level 3/2 universal and E2 for Level 2 charging station. In this embodiment, at least two or more connector interfaces are included to allow power delivery to EVs with any one or a plurality of plug types. The charging station 50 includes a J-1772 A or JI 772E connector 52, an automobile brand-specific connector 54, a CHAdeMO connector 56, and a J-1772E combo connector 58. The J-1772E combo is not a standard yet and does not have an official designation. It has been referred to as J-1772 combo or J-1772 DC. The connector location depicted by the drawing is for illustration only and does not solidify a design specification, i.e. the plug type and side location may be changed if needed. Currently, a J-1772E connector 58 is a planned future install to the system 50 when it becomes a standard. The quick-charging station system 50 has the ability to deliver both Level 3 DC to DC quick charge and Level 2 AC to DC (up to 70 Amps delivery). The quick-charging station system 50 can charge at least two EVs simultaneously.

The quick-charging station system 50 includes a touch-screen device 60 that allows the consumer/user to receive, send, and interact with web-delivered media and content. The touch-screen device 60 includes a 15-inch (diagonal) or larger touch screen. An interface is interconnected with the quick-charging station system 50 using Web portal, Small Business Portal (SBP), mobile app services and the like. The quick-charging station system 50 further includes a specialized button 64 that allows a consumer/user to select an item displayed on the touch screen 60. The specialized button 64 is an activator that causes selected web content to be sent to a mobile application on the consumer's/user's patron's phone. The button 64 may be a physical depressible button or a screen-represented button.

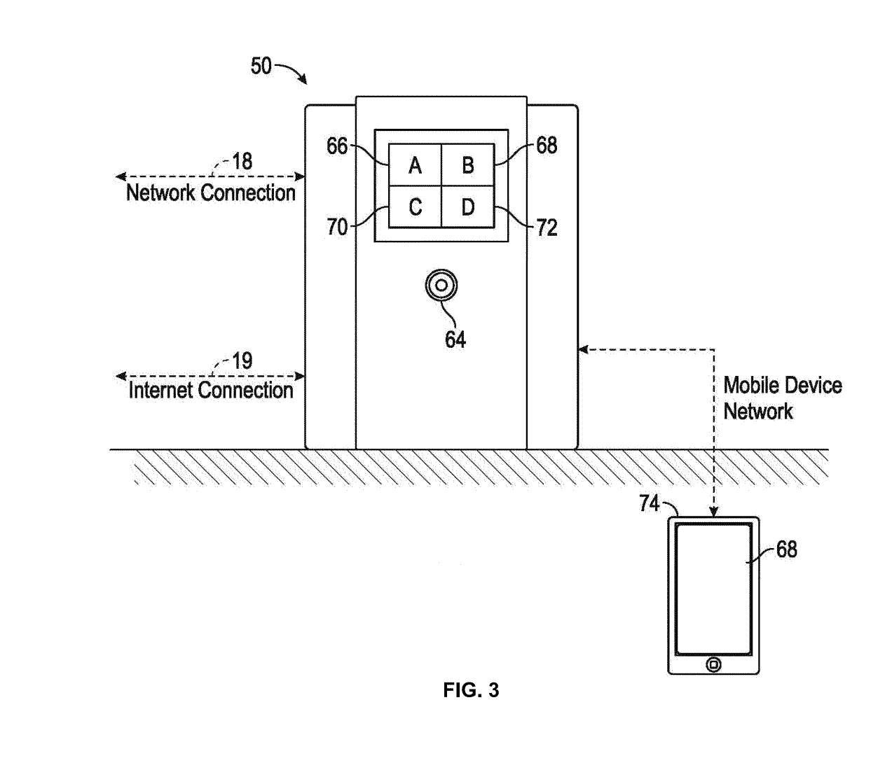

Web-based or consumer-focused content is displayed on the touch screen 60 using multiple portals 66, 68, 70 and 72, as shown in FIG. 3. This allows many web feeds, email, ads, entertainment, web commerce, social media, and any other type of consumer-focused content (represented as 66, 68, 70 and 72 on FIG. 3) to be simultaneously displayed to the consumer/user. One type of consumer-focused content that may be displayed on one of the portals is the location and distance to adjacent charging nodes. When the consumers/users see an ad or other web content that interests them, they push the specialized button 64 causing a copy of the web content to be sent to their mobile device 74. The mobile device includes but is not limited to a smart phone, tablet, laptop and the like. A mobile application that is compatible with the interface is installed on the mobile device that is linked to the customer's ID number, allowing for routing of the selected web content to their mobile device. The updated mobile application interfaces with a plurality of web-based services, such that the user can accomplish most related tasks within the inventive app.

A type of interface that can be used with the quick-charging station system 50 is a small business portal (SBP). The SBP is a service that allows businesses selling goods or services to advertise through the quick-charging station system 50. A key differentiator of a SBP is that the marketing information provided by the small business is concentric to the charging station 50 up to a set distance. As an example, data concerning a restaurant located approximately 10 miles from a charging station 50 are displayed, but a different restaurant located 25 miles, 50 miles and like was not be displayed on that charging station 50. This allows the customer to receive advertising that is regional to a particular charging station 50. The web content that is displayed may be defined as being within a predetermined distance to the business being served. The concentric mile ranges are up to about 35 miles, as the chargers are going to be placed every 50 to 70+/−10 miles. Concentric advertising offers a lower price point with greater effective targeting and is therefore expected to be rapidly adopted by local companies. While charging their EVs, the customers will see one or more ads for goods and services regional to that charging station 50.

The business and points of interest at present are limited by their owners' ability to pay. For example, a small bed and breakfast must pay tens of thousands to be on hotels.com. This new system will offer a more affordable option as well as greater customer location specificity for local business because it is regional to each charger station. The current options miss local companies that cannot afford to pay, or do not pay because they do not fit the featured categories. Popular search engines often miss the less connected businesses and points of interest in smaller towns. Beyond that, the inventive SBP is designed for Local news, Chat rooms, Blogs, Postings, Videos (like an ice sculpture in the town square can be posted for visitors to discover), web stores both for stores local to the charger and Internet wide. I employ an Auctions system (local and Internet wide) or provide a new version. In another embodiment, the SBP offers coupons that are local to the charger, as well as the option to make reservations. In another embodiment, I provide exclusive or non-exclusive travel discounts that are local to the charger. In yet another embodiment, SBD features events and regional calendars that are local to the charger. In another embodiment, the SBP provides access to educational and non-profit groups, students, startups and others doing good for the community.

In yet another embodiment, a specialized button 64 that functions as a unique, “fun” selector. Whether the specialized button is the physical version on the front of the recharger or is an on-screen software it will look the same. I intend to vary the color for material or intent. For example, when the on-screen specialized button is red instead of green, it signifies a non-selectable item.

The SBP software is under constant development, as access is sold or given to small business, persons, or groups.

My portal allows for access to other portals without leaving SBP. Many features are intended to be available through the SBP portal. In contrast, Facebook is a closed system with strong limits on access to outside systems to protect personal information; this requires the user to open multiple apps to accomplish tasks that can be done within my inventive app. In one embodiment, the SBP system is an open method allowing access to outside features/services. All likes and preferences are tagged to the customers' charging account or fab and not to their personal information. For example, my system records the unique key fab number with likes for personal preferences such as pizza and museums. In the location where the charging occurs, these personal preferences are accessible, and the customer is matched with advertisements for those preferences while charging. What the SBP system will not know is the identity of the customer who likes pizza and Barbie® museums. As such, this system offers high degrees of privacy and security.

In one embodiment, the display on the charging station is preferably quartered, allowing for four points of content (66, 68, 70 and 72). When a digital version of the specialized button is present, it is either at the center of the four screens or along the right/left border. In another embodiment, this preference is user configurable.

The SBP system offers options of both free and purchased content. To purchase content, the customer has the option of using an account-linked key fab, an electronic payment system, or a credit card.

On FIG. 2 between 58 and 60, there is a smaller 5.7-inch screen, which includes a programmable logic controller (PLC) added by the manufacturer to control which charger is in use.

### Example 1

### Universal Charger

In one embodiment the current invention's universal charger system has both level 3 and level 2 charging capabilities. This charger provides quick charging at the 20 kW, 30 kW, 40 kW, and 50 kW rating Level 3 with the Level 2 charging at about 16.8 kW (240 Volts at 70 Amps). The Level 3 service is provided via a plurality of dissimilar adaptors with the Level 2 service also provided via a plurality of dissimilar adaptors. The adapters are the interface between the charge station and the electric vehicle to facilitate recharging of the electric vehicle battery. The adaptors have the ability to be interchangeable with respect to position, retrofit, upgrade, or repair. The universal charger system charges a plurality of electric vehicles simultaneously. A variation of the charger system also has an attachable shade apparatus. The shade apparatus provides cover from direct sunlight and protection from adverse weather conditions. During low light conditions the shade apparatus illuminates the charger. This apparatus features mounting mechanisms for attachment to the charger system, self-contained solar collector and power storage system, illumination source, and security camera option. Optionally, the solar collector, power storage system, illumination source, and security camera are attached directly to the charger system.

### Example 2

### Network and Advertising Technology

The inventive charger network is composed of various chargers and partnered electric vehicle supply equipment (EVSE) that are networked through cell, wireless, or wired means to function as network nodes. This is the foundation of my state-to-state and nationwide recharging network. The network nodes share data between nodes and other data managing systems to push and pull advertisements and user content between servers and end users. For the end users, this content is preferably displayed on touch screens. Web content may also be viewed through any technology able to connect to my multi-portal system, including, but not limited to, cell phones, laptops, etc. The portel content is broken into quadrants allowing for multiple channels of content. Devices with a smaller view contain a screen for content delivery displays in a convenient format. Interactive data between the user and the inventive system are collected and linked to the user's fab Number on the system. The advertising content is customized to user preferences and history, as well as to the regional area. When a user selects an ad, additional information associated with the ad is transmitted to the user. The information is received on the user's mobile device using a convenient application. Preferably, the application enables communication with the subject of the ad.

### Example 3

### Communication Content and Engagement System

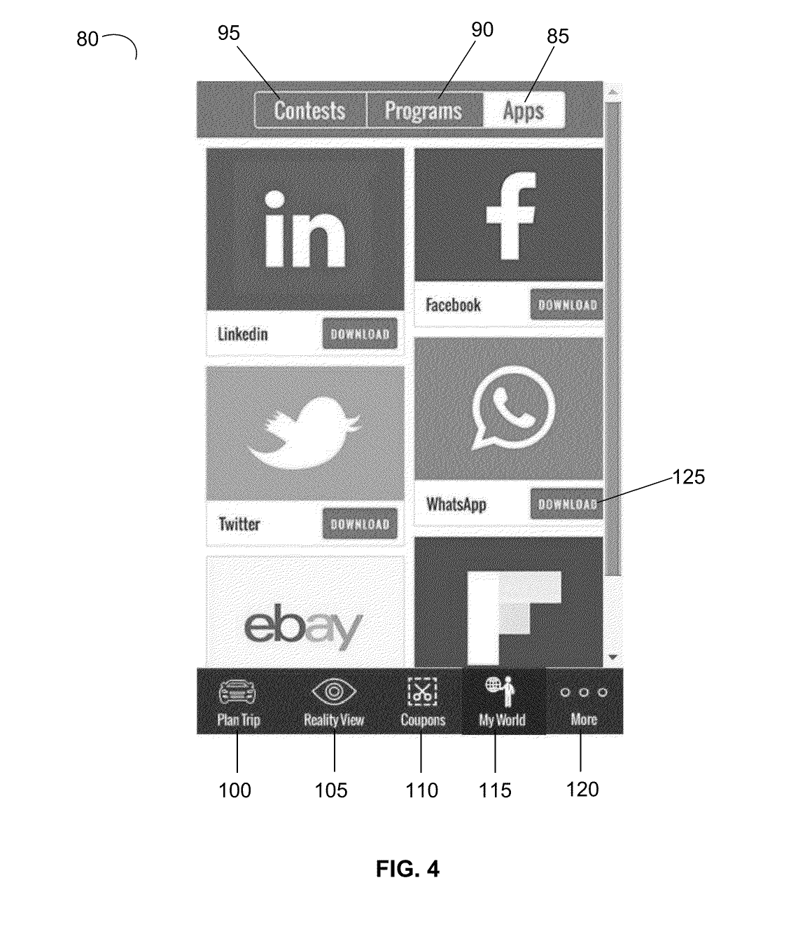

In addition to the basic communications and displays of Example 2, I contemplate a broader range of communication, content and engagement. This is most conveniently done through one or more mobile applications (hereinafter “the app”). FIG. 4 displays an exemplary screen 80 of the app. Buttons across the top provide access to a variety of computer applications or apps 85, programs 90 and contests 95. Buttons across the bottom of the screen 80 provide access to plan-trip functions 100, a Reality View 105, Coupons 110, My World 115 and additional screens 120. In FIG. 4, the “Apps” button 85 is highlighted and the user's favorite applications appear: in this example, various social media sites are available for access and use. Each of these preferably has a download button 125.

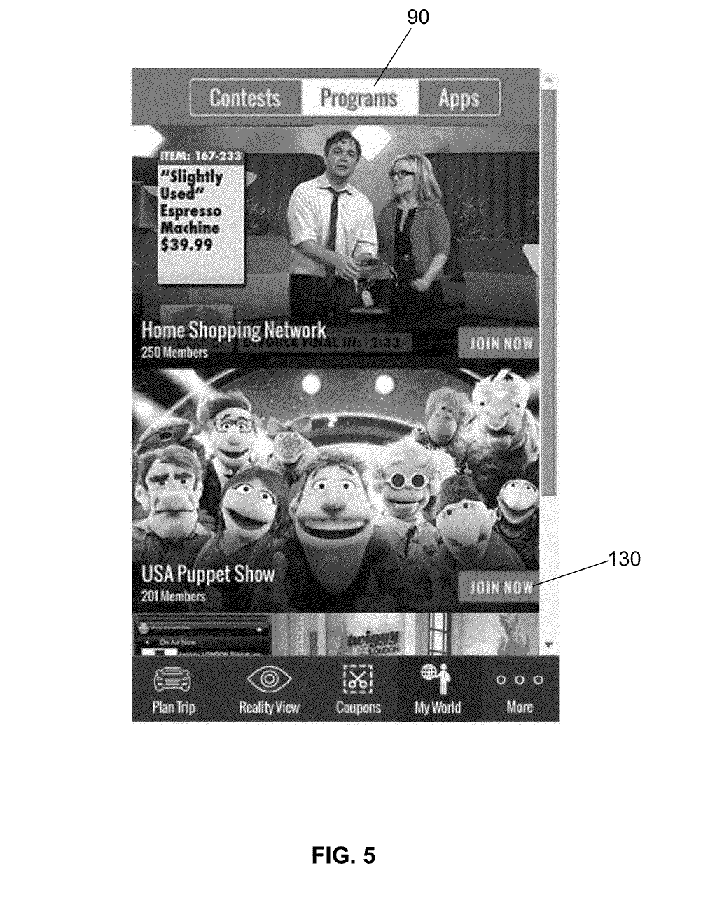

FIG. 5 shows a screen when the “Programs” 90 button is selected. TV programs on selected stations are shown and each screen has a “Join Now” button. On the right is a scroll bar to move to other favorite programs.

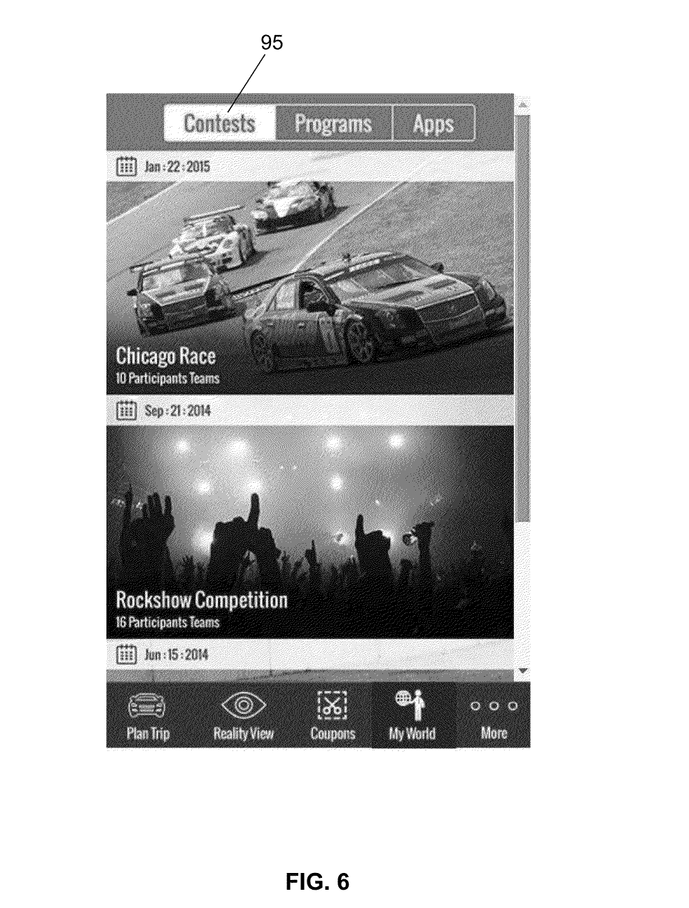

FIG. 6 shows a screen for the Contests 95 selection. The user selects an in-progress contest by scrolling down.

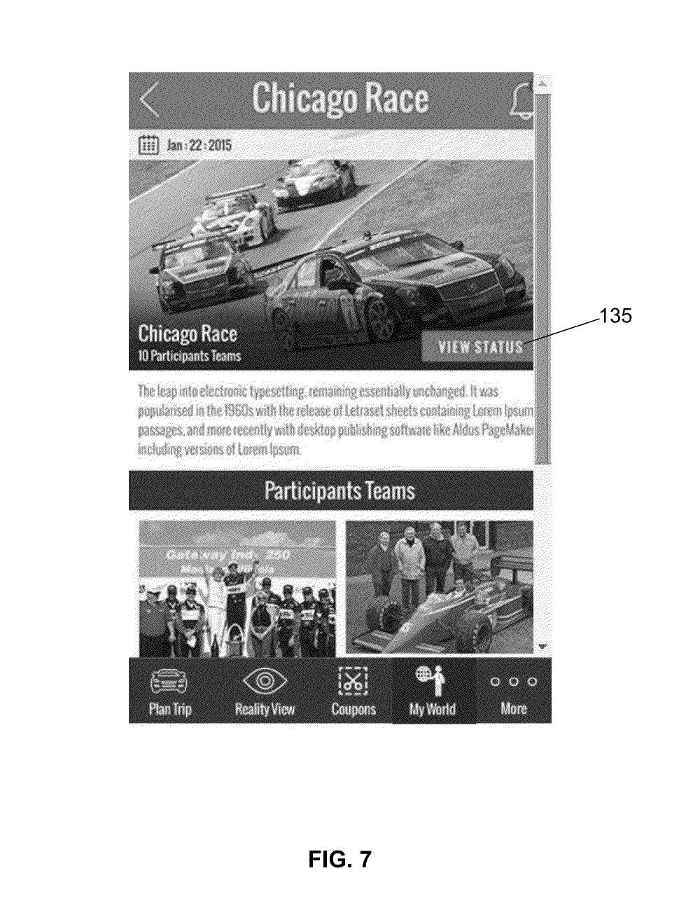

FIG. 7 shows a screen that appears after a popular race was selected from the FIG. 6 screen; scrolling down reveals even more information. The “View Status” button 130 enables the user to update the screens.

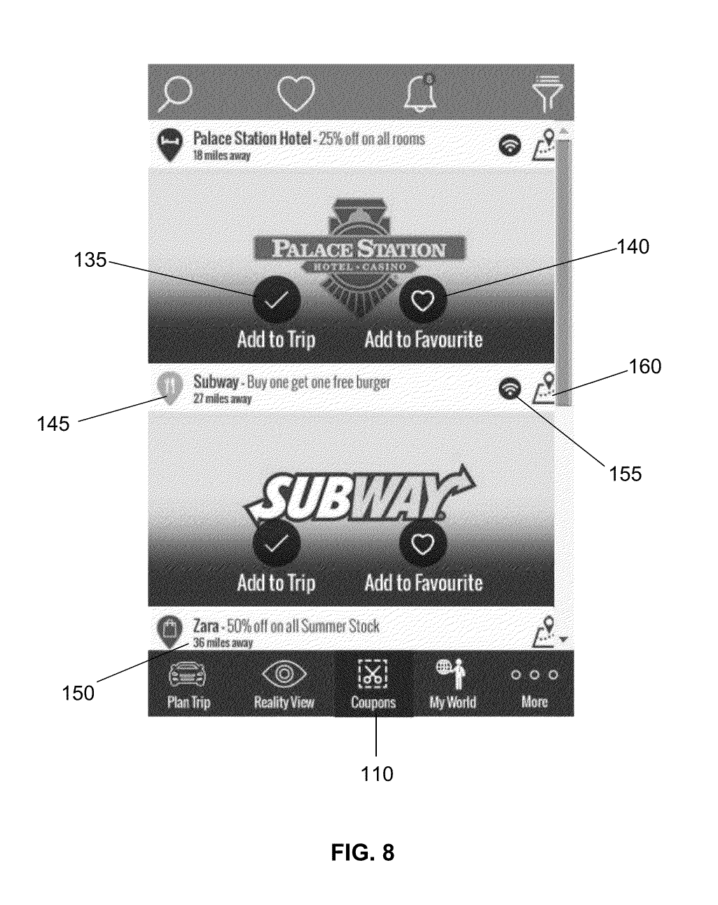

FIG. 8 shows an exemplary screen that is accessed by tapping the “Coupon” button 110. A series of coupons is displayed and the user scrolls to see them. Note that each displayed coupon also shows available deals, distance to the location and two buttons: “Add to Trip” 135 and “Add to Favorite” 140. In this embodiment, the screen also displays the type of merchandiser 145 and distance 150. There is a button 155 to listen to and/or watch a commercial. Another button 160 is accessed by the user who wants to further interact with the system.

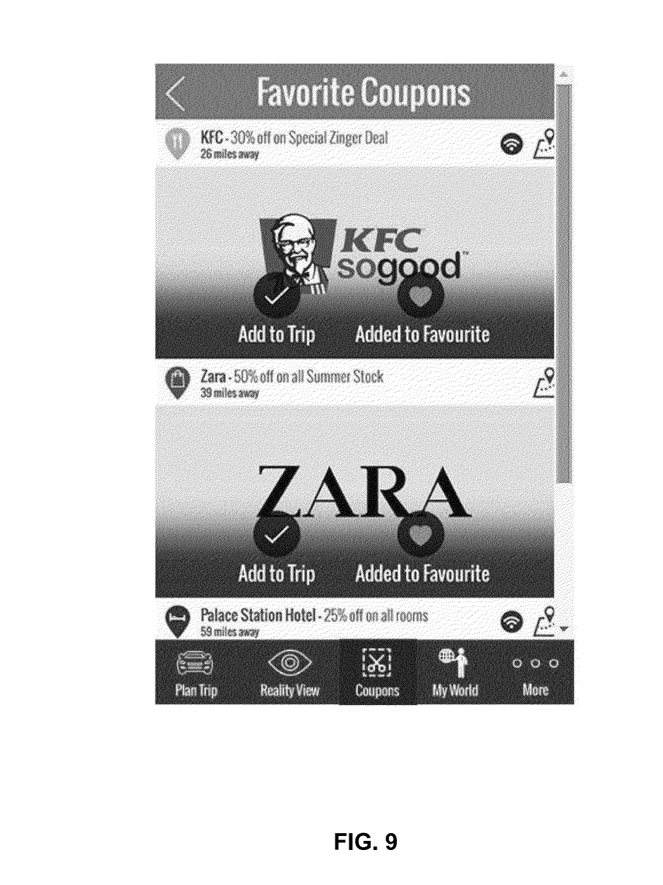

FIG. 9 shows a screen with Favorite Coupons that have been selected by the user who has certain merchandisers he or she likes to frequent.

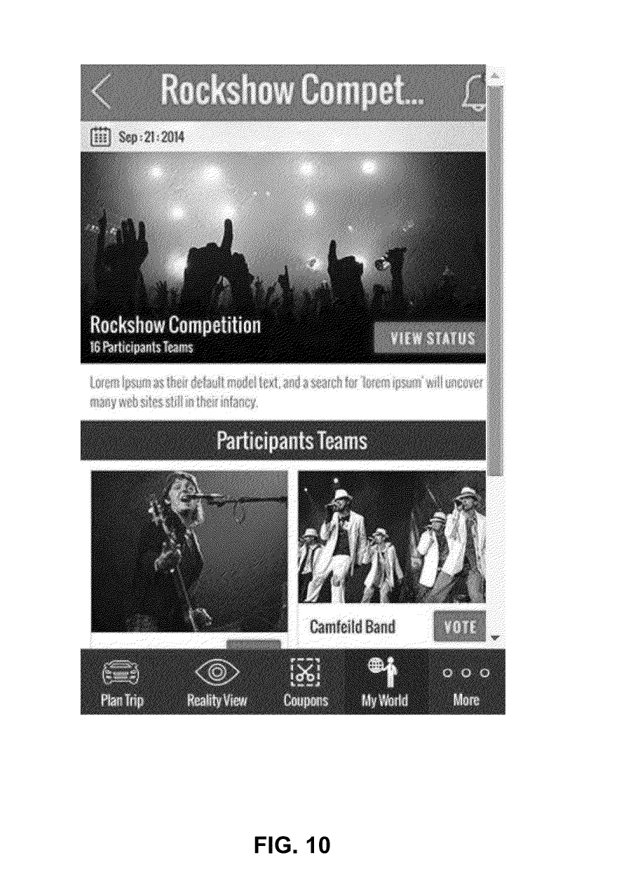

FIG. 10 shows a rock show competition with View Status and Vote capability.

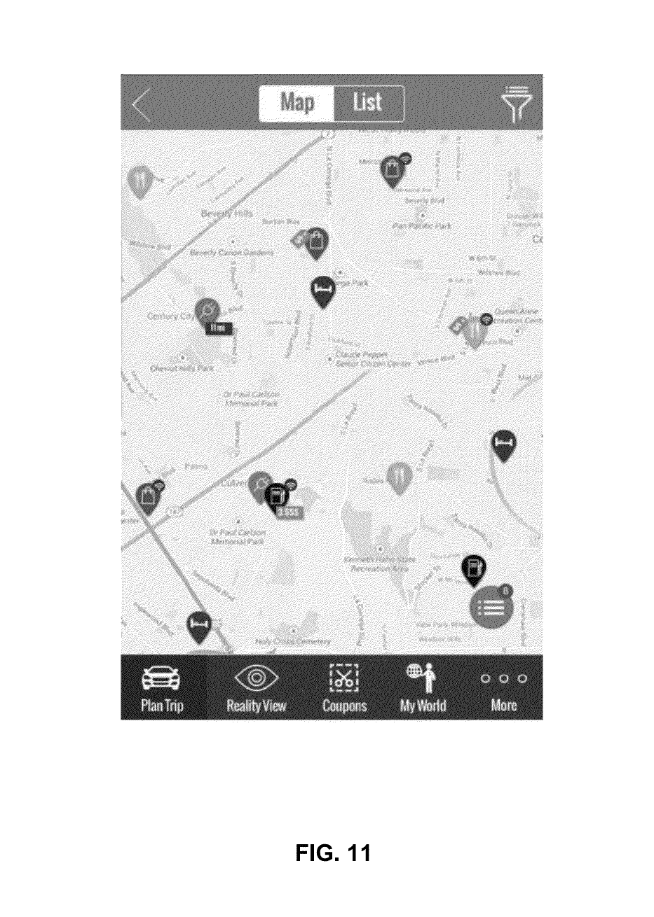

FIG. 11 shows a typical user favorite function utilizing a map to plan a trip. With selected routing and a previous list of favorite places, the map displays the nearby restaurants and other establishments. The map shows the favorite places clustered in a typical shopping center configuration.

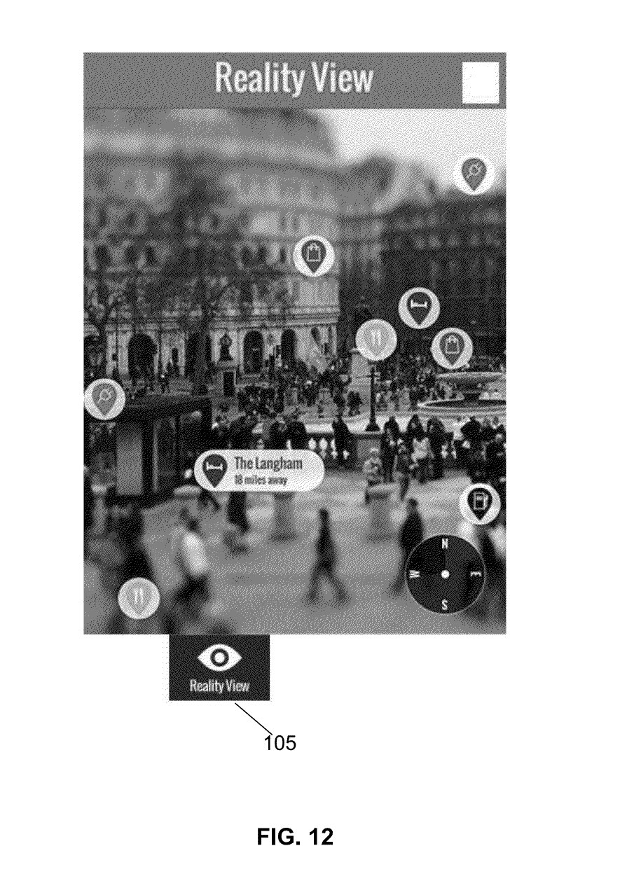

FIG. 12 shows a screen when the “Reality View” button 105 has been selected. In this embodiment, the locations and images of favorite establishments are also shown by their symbols and logos.

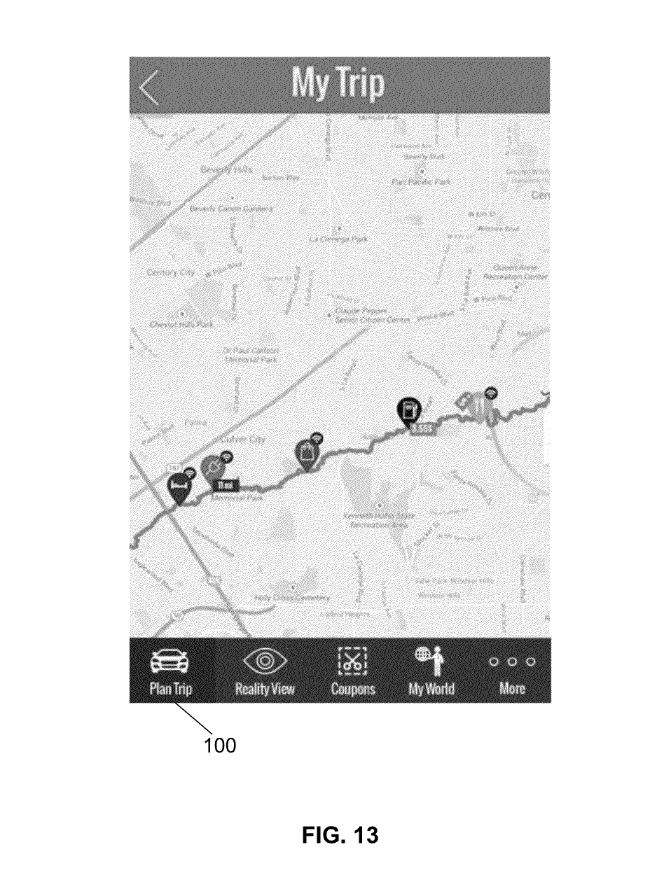

FIG. 13 shows a screen for My Trip that has been planned via the “Plan Trip” button 100. This illustrates an example of a trip route, showing not just the automobile route, but also establishments along the routing.

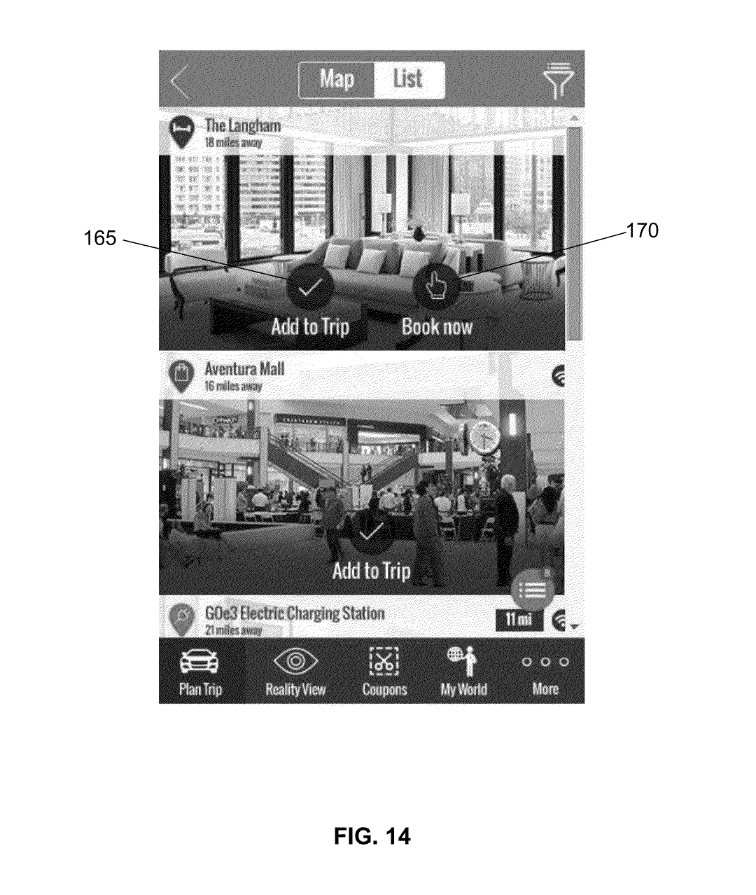

FIG. 14 shows a screen with more information about a planned trip. Notice that a button for “List” has been actuated. The List has a series of establishments for the trip. Some have had the “Add to Trip” 165 button checked. An additional function is shown with the “Book Now” button 170. Optionally the app connects the user with hotels and restaurants for convenient reservations, for which the hotel or restaurant may pay a commission to the app operator. This takes place “inside” the app for user convenience.

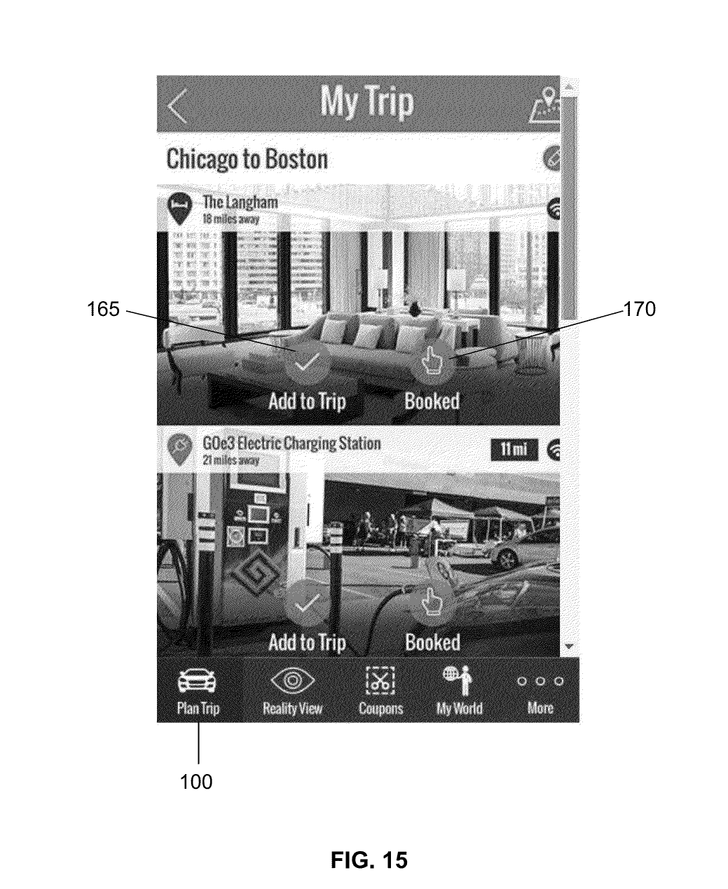

FIG. 15 displays a similar screen but is labeled My Trip. Note that the “Add to Trip” button 165 has changed color, as has the other “Booked” button 170.

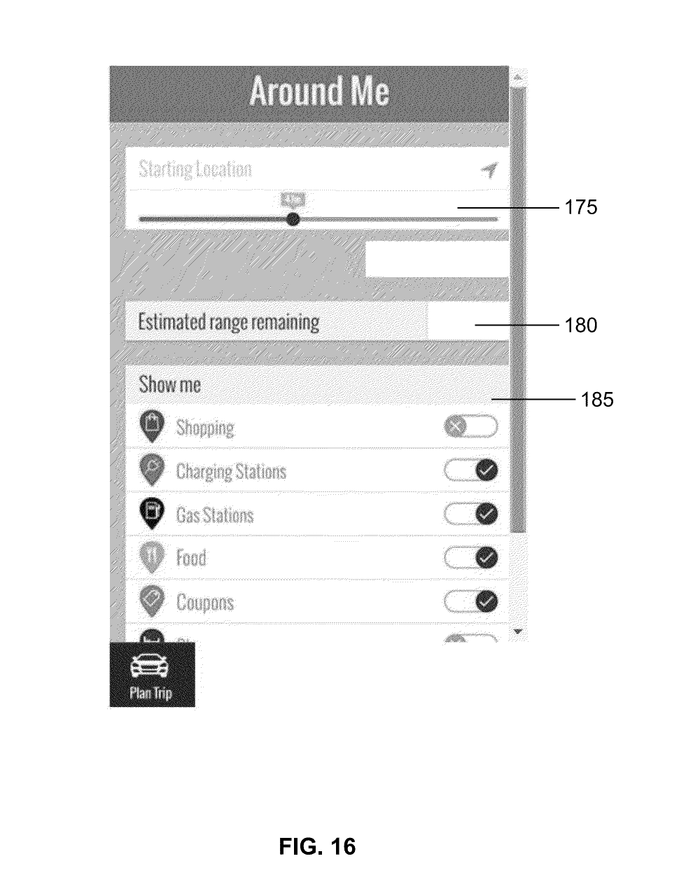

FIG. 16 shows an additional screen under the plan trip function is labeled Around Me. At the top is a starting location indicator 175, such as a recharging station. A box 180 reports an estimated range remaining. The next area is labeled Show Me 185, for a list of destinations that can be selected, including but not limited to shopping (checked), charging stations, gas stations, food and coupons.

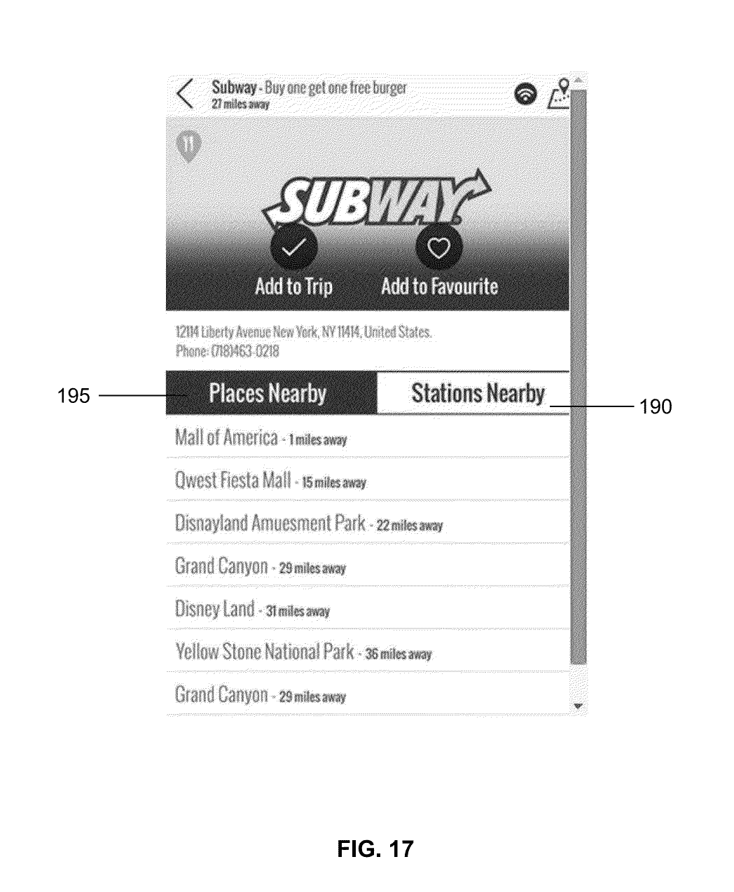

FIG. 17 shows a screen with a deal for a restaurant that can be added to the trip and/or to favorites. These are selected and proposed by the app based on the user profile and prior user activity. Here, the user can select for Stations Nearby 190 or for Places Nearby 195 to complete planning a trip.

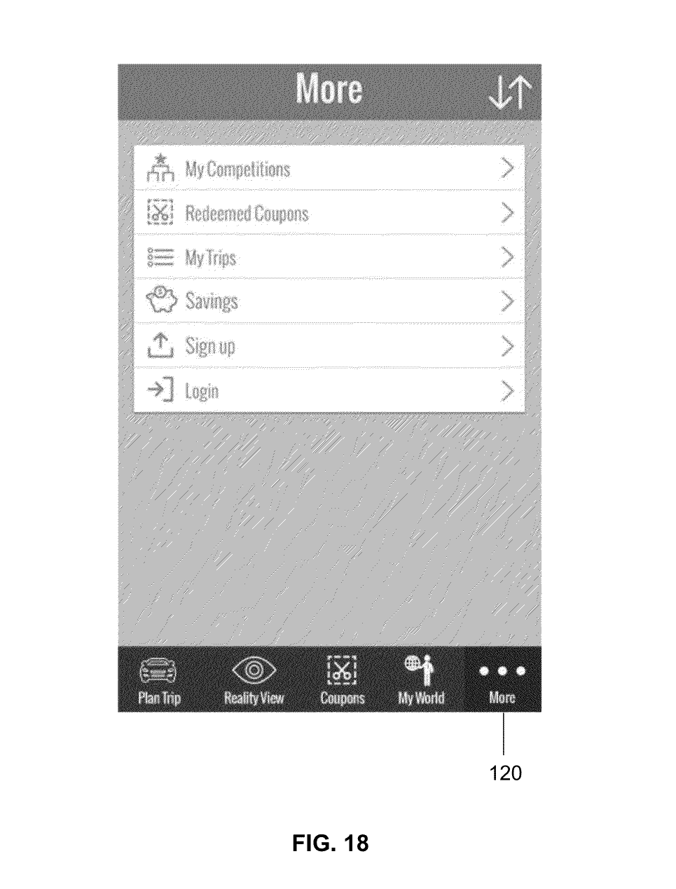

FIG. 18 shows yet another screen when the “More” button 120 of FIG. 4 is pressed. This has a variable number of items displayed. The list shown includes but is not limited to competitions, redeemed coupons, my trips, various monetary savings, sign up and login.

The foregoing outlines some of the contemplated functions of the new app for EV charging stations. As one skilled in the art knows from the foregoing, functions can be added and deleted as determined by customer needs and dislikes (hence the more screens).

Those of ordinary skill in the art will appreciate that the foregoing description is illustrative of the invention. The disclosure is not intended to be limited to the specific embodiments described above. The details of the materials used, the uses described, and the arrangement and type of mechanical objects of the invention can be altered without materially changing the scope of the instant invention. It is to be understood that the above description has been made in an illustrative fashion, and not a restrictive one. Combinations of the above embodiments, and other embodiments not specifically described herein will be apparent to those of skill in the art. The scope of the various embodiments of the invention includes any other applications in which the extension device is used. Therefore the scope of the inventive concept, including all of its embodiments and appended claims, along with a full range of equivalents should be considered to be the full inventive concept.

The foregoing examples and description should not be construed to be the only features of the invention, nor should the examples be limiting to the inventive concept. The claims appended to this disclosure reflect subsets of the instant invention. The appended claims, and all claims, which may be later added, are hereby incorporated into the description of the embodiments of the invention, with each claim standing on its own as a separate preferred embodiment.

Each statement of an embodiment or example is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional un-recited elements or method steps. “Comprising” is to be interpreted broadly and including the more restrictive terms “consisting of” and “consisting essentially of.”

1. An electric vehicle-charging station system comprising:
a) A plurality of charging nodes, each charging node including a charging station having at least two electric vehicle supply equipment selected from the group consisting of a Level 1 charging device, a Level 2 charging device, an automobile brand-specific charging device, and a Level 3/Fast DC charging device, wherein the plurality of charging nodes are in communication with each other through a network. The plurality of charging method inputs includes, but is not limited to, a CHAdeMO quick charging input, a J1772E charging input, and a 70 A Level II automobile brand-specific input;
b) A display device disposed on each charging station, the display device having one or more portals that display a web-based or consumer-focused content, wherein a portion of the content is provided by a vendor that provides a good or service concentrically located within a predetermined distance to the system, and another portion of the content provides the location of adjacent charging nodes to a consumer using the system to charge an electric vehicle; and
c) A selection device that allows the consumer to select a particular portal, wherein the selection device transmits the selected content to a mobile device associated with the consumer.

2. A system for communicating with and through electric vehicle stations, the system comprising:
a) An electric vehicle charging station, comprising level 2 and level 3 combination units;
b) A Wi-Fi enabled station, allowing communication between a customer device and the station;
c) A networked station allowing communication between the inventor's company systems, company advertisers, and the current invention along with its plurality.
d) A mobile software application (“app”) causing a smart phone or other computing device to display the status of the input of the plurality, along with various company offerings and services; and
e) A screen for programs, the programs comprising coupons, “my world,” and user selected applications.

3. The system of claim 2, further comprising a screen for selecting and playing TV programs.

4. The system of claim 2, further comprising a screen for contests in which the user chooses the contests to enter and/or to follow.

5. The system of claim 2, further comprising a screen for coupons, commercials, and sale alerts.

6. The system of claim 2, further comprising a screen for various payment methods.

7. An electric vehicle charging station system comprising:
a) a plurality of charging nodes, each charging node including a charging station capable of charging at least two electric vehicle supply equipment simultaneously and having at least two connector interfaces selected from the group consisting of a Level 1 charging device, a Level 2 charging device, a Tesla charging device, and a Level 3/Fast DC charging device, wherein the plurality of charging nodes are in communication with each other through a network;
b) a display device disposed on each charging station, the display device having one or more portals that display a web-based or consumer-focused content, wherein a portion of the content is provided by a vendor that provides a good or service concentrically located within a predetermined distance to the charging station, and another portion of the content provides the location of adjacent charging nodes to a consumer using the charging station to charge an electric vehicle; and
c) a selection device that allows the consumer to select a particular portal, wherein the selection device transmits the selected content to a mobile device associated with the consumer.
